(19) United States
(12) Patent Application Publication
(10) Pub. No.: US 2008/0192197 A1
(43) Pub. Date: Aug. 14, 2008

(54) LIQUID CRYSTAL DISPLAY ELEMENT AND METHOD FOR MANUFACTURING THE SAME

(76) Inventor: Kazuhiro TAKAHASHI, Kanazawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/027,624

(22) Filed: Feb. 7, 2008

(30) Foreign Application Priority Data
Feb. 8, 2007 (JP) 2007-029537

(51) Int. Cl. G02F 1/1333

(52) U.S. Cl. 349/160; 349/187

(57) ABSTRACT

Contact holes and dummy holes are formed in the gate insulating film and the interlayer insulating film located in the non-display region of an array board by dry etching. Since the opening area ratio of the array board is increased, the variation amount of luminescence of etching gas during dry etching is large, and thus a just etching timing can be easily detected by detecting this variation amount.

### INCORPORATION BY REFERENCE

The present application claims priority under 35 U.S.C. §119 to Japanese Patent Application No. 2007-029537 filed on Feb. 8, 2007. The content of the application is incorporated herein by reference in its entirety.

### FIELD OF THE INVENTION

The present invention relates to a liquid crystal display element having an array board provided with an insulating film, and a method for manufacturing the same.

### BACKGROUND OF THE INVENTION

A conventional liquid crystal display element of this type includes an array board, a counter board disposed so as to face the array board, and a liquid crystal layer provided between the array board and the counter board, and has a display region in which a plurality of pixels are arranged in a matrix form and a non-display region located around the display region.

The array board is provided with a glass board as an insulating board, and switching elements for driving respective pixels are formed in the form of film on one principal surface of the glass substrate. In addition, gate lines which are electrically connected to the gate terminals of the switching elements and signal lines and drain lines which are electrically connected respectively to the source terminals and drain terminals of the switching elements are also formed in the form of a film on the one principal surface of the glass substrate.

An insulating film for electrically insulating the films as described above is formed between the films. An opening pattern corresponding to a pattern of a contact hole is formed at a predetermined position in each insulated film, for example, by a dry etching process so that the insulated films are electrically connectable to each other.

In the dry etching process as described above, an etching wave pattern, that is, the amount of luminescence of etching gas (F gas) due to plasma is detected, and a timing at which etching has been completed, that is, a just etching timing is detected on the basis of variation of the luminescence amount.

That is, as described in Japanese Laid-Open Patent Publication No. 2006-100672, the occupation amount of etching gas used for dry etching in the atmosphere inside a chamber decreases because it is consumed during the etching, and thus the luminescence intensity is decreased. Therefore, when the etching is completed, the amount of consumption of the etching gas is decreased, so that the amount of the etching gas in the atmosphere inside the chamber increases and thus the luminescence intensity is increased. Accordingly, the just etching timing can be detected by detecting the variation of the luminescence intensity.

On the other hand, in the liquid crystal display element described above, the opening pattern formed in the insulating film may have a small area ratio (insulating film opening area/glass board area) in some cases, and thus the variation amount of luminescence is relatively small. In such a case, there is a problem that it is not easy to detect the just etching timing and an operation failure (an end-point defect) may occur due to the failure of the just etching detection.

The present invention has been implemented in view of such a problem, and has an object to provide a liquid crystal display element which can easily detect a just etching timing, and a manufacturing method thereof.

### SUMMARY OF THE INVENTION

According to the present invention, a liquid crystal display element including a display region having a plurality of pixels and a non-display region located exterior of the display region includes: an array board having an insulating film; a counter board disposed so as to face the array board; a liquid crystal layer interposed between the array board and the counter board; an opening pattern formed in the insulating film located at least in the display region by dry etching; and a dummy opening pattern that is formed in the insulating film located in the non-display region by dry etching separately from the opening pattern.

The opening pattern and the dummy opening pattern different from the opening pattern are formed in the insulating film located in the non-display region of the array board by the dry etching, thereby improving the opening area ratio of the array board. Therefore, the variation amount of luminescence of etching gas during the dry etching is increased, and a just etching timing can be easily detected by detecting this variation amount.

### BRIEF DESCRIPTION OF THE DRAWINGS

FIG. 1 is an enlarged plan view showing the main portion of a liquid crystal display element according to the first embodiment of the present invention.

FIG. 2 is an explanatory cross-sectional view showing the main portion of an array board of the liquid crystal display element.

FIG. 3 is a circuit diagram showing a pixel of the liquid crystal display element.

FIG. 4 is an explanatory cross-sectional view illustrating the liquid crystal display element.

FIG. 5 is an explanatory plan view illustrating the liquid crystal display element.

FIG. 6 is a graph showing variation in the amount of luminescence of the liquid crystal display element during dry etching.

FIG. 7 is a graph showing the relationship between an opening area ratio and an end-point defective fraction of the liquid crystal display element.

FIG. 8 is an enlarged plan view of the main portion of a liquid crystal display element according to the second embodiment.

### DETAILED DESCRIPTION OF THE PREFERRED EMBODIMENT

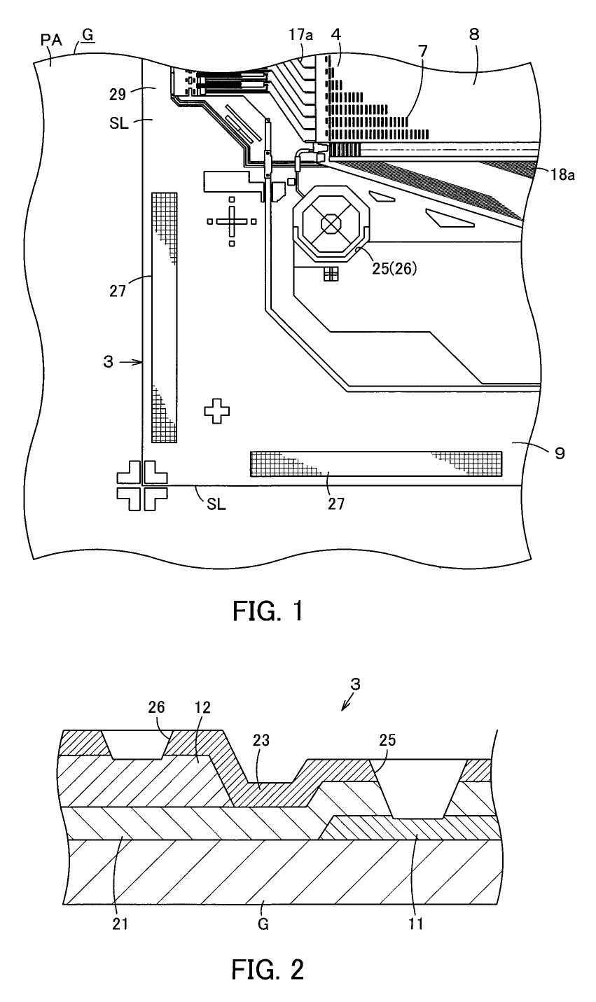

The construction of a liquid crystal display element of a first embodiment of the present invention will now be described with reference to FIG. 1 to FIG. 7.

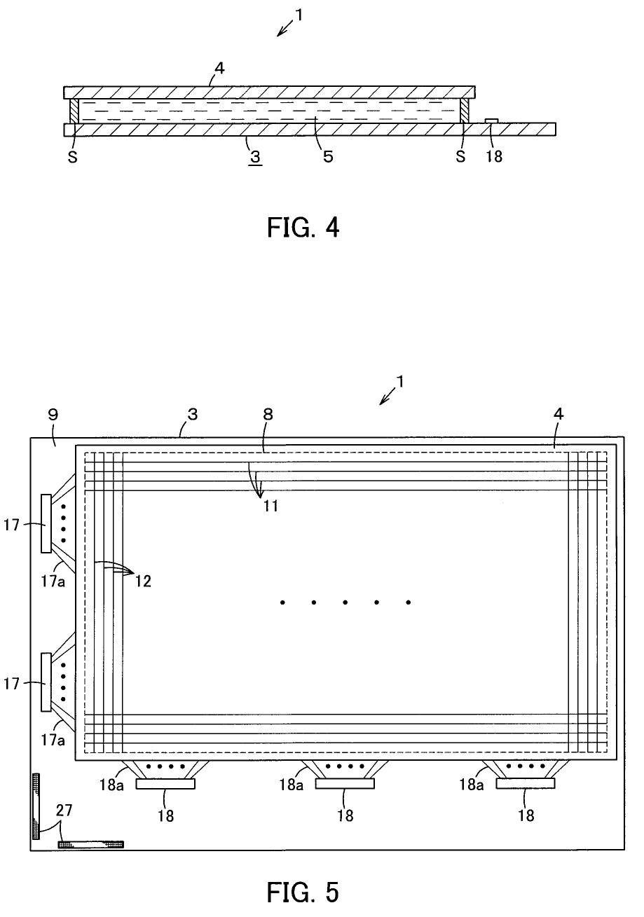

In FIG. 4, reference numeral 1 represents an active matrix type liquid crystal panel as a liquid crystal display element. The liquid crystal panel 1 includes an array board 3, a counter board 4, a liquid crystal layer 5 sandwiched between the array board 3 and the counter board 4. The array board 3 and the counter board 4 of the liquid crystal panel 1 are adhesively attached to each other by a sealing agent S while the liquid crystal layer 5 is held between the array board 3 and the counter board 4. Polarization plates (not shown) are arranged on the respective outer surfaces at the outside of the array board 3 and the counter board 4 so that the polarization axes thereof are perpendicular to each other. Furthermore, as shown in FIG. 1, a planar rectangular display region 8 which has a plurality of pixels 7 arranged in a matrix form and can display an image is provided at the center portion of the liquid crystal panel 1, and an on-display region 9 which is located around the display region 8 and in which no image is displayed.

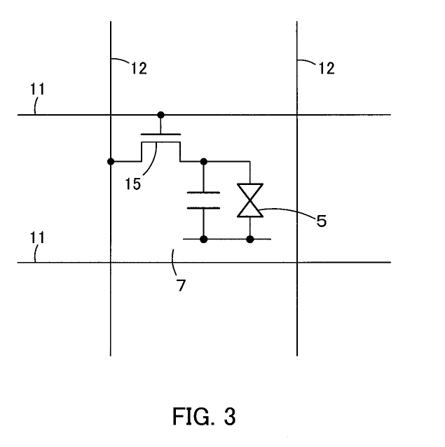

In the array board 3, gate lines 11 and signal lines 12 which are scan lines are arranged on the inner surface corresponding to one principal surface of a glass board G as an insulating board having translucence so as to be substantially perpendicular to one another as shown in FIG. 3 and FIG. 5. Furthermore, the pixels 7 of the display region 8 are located in the respective areas partitioned and surrounded by the gate lines 11 and the signal lines 12. Each of the pixels 7 is equipped with a thin film transistor (TFT) 15 as a switching element, a pixel electrode (not shown) electrically connected to the thin film transistor 15, and a counter electrode (not shown) provided to the counter board 4. Furthermore, a gate driver 17 as a scanning driver and a source driver 18 as a signal driver are mounted on respective portions projected from the display region 8.

The gate lines 11 supply a control signal for controlling ON/OFF of the thin film transistors 15. They are formed in the form of films by laminating components of aluminum (Al) and molybdenum (Mo), for example, and wired so as to be spaced from one another at equal intervals parallel to one another along the lateral direction of the array board 3. As shown in FIG. 2, a gate insulating film 21 as an insulating film is formed on the gate lines 11 between the signal lines 12 and the gate lines 11. The gate insulating film 21 is formed of silicon nitride (SiNx) or the like so as to have a film thickness of about 0.38 μm.

Furthermore, the signal lines 12 supply an image signal as a voltage corresponding to image data. They are formed in the form of films by laminating compounds of titan (Ti), aluminum, molybdenum or the like and wired so as to be spaced from one another at an equal interval parallel along the longitudinal direction of the glass substrate G. Accordingly, each signal line is wired to be perpendicular to each gate line 11 at least at a part thereof. Furthermore, an interlayer insulating film 23 is formed on the gate insulating film 21 so as to cover the signal lines 12 as the insulating film having the insulating performance. This interlayer insulating film 23 is formed of silicon nitride or the like at a film thickness of about 0.27 μm.

In the gate insulating film 21 and the interlayer insulating film 23 are formed a contact hole 25 corresponding to an opening pattern of an exposed portion which penetrates through the insulating films 21, 23 and from which a part of the gate line 11 is exposed, a contact hole 26 corresponding to an opening pattern as an exposed portion which penetrates through the interlayer insulating film 23 and from which at least a part of the signal line 12 is exposed, and dummy holes 27 as dummy opening patterns shown in FIG. 1 by dry etching.

The dummy holes 27 are formed not to be electrically connected to any line. For example, they are formed in an elongated rectangular shape along the side portion of the glass board G in the neighborhood of a corner portion of the glass board G at a position corresponding to the non-display region 9 on the glass board G, and have minute hole portions arranged in the form of a grid.

Here, when these contact holes 25 and 26 and the dummy holes 27 are formed by the dry etching, an etching waveform corresponding to a plasma luminescence amount in a vacuum chamber of an etching device (not shown) is measured by a luminescence measuring unit as terminal point detecting means, and the just etching timing is set on the basis of the variation amount of the waveform.

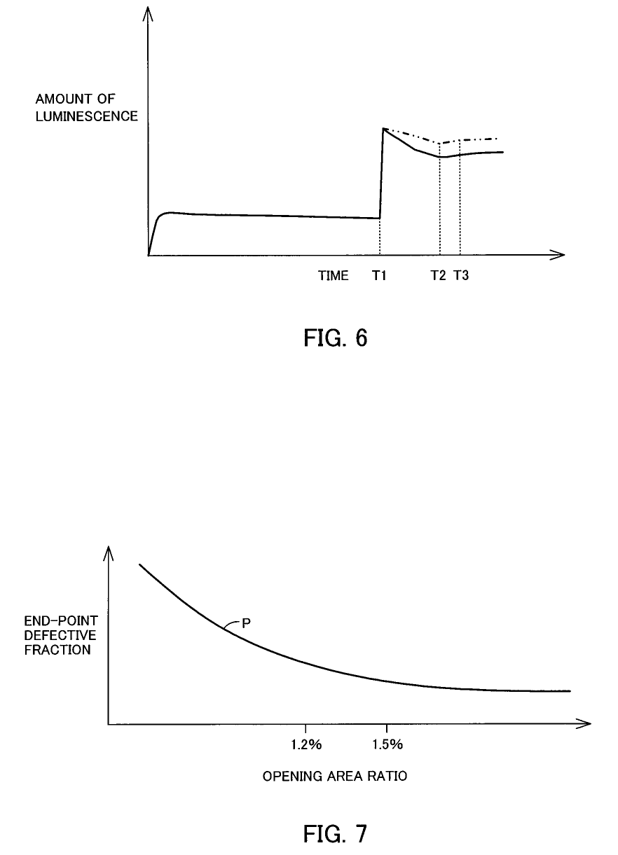

At this time, when the opening area to the board area of the glass board G, that is, the opening area ratio is less than 1.2% as shown in FIG. 7, the variation amount of the etching waveform is small (an imaginary line of FIG. 6), and thus it is not easy to detect the just etching timing by the luminescence measuring unit. Therefore, the terminal point defective fraction, that is, the end point defective fraction P is increased. On the other hand, when the opening area ratio is larger than 1.5%, the end point defective fraction P is substantially unvaried, however, the amount of etching gas to be consumed is increased, and undue time is required to process the respective holes 25, 26 and 27. Therefore, it is preferable that the opening area ratio is set at a range from 1.2% to 1.5%. The dummy hole 27 has a larger opening area ratio than the contact holes 25 and 26.

Furthermore, with respect to the thin film transistor 15, the gate electrode thereof is electrically connected to the gate line 11, the source electrode thereof is electrically connected to the signal line 12 and the drain electrode is electrically connected to the pixel electrode, and the thin film transistor 15 is subjected to ON/OFF control by a control signal input to the gate line 11, and it can display a predetermined image in the display region 8 by writing a pixel signal input to the signal line 12 to the pixel electrode.

The gate drivers 17 input various kinds of control signals to the gate lines 11. As shown in FIG. 5, the gate drivers 17 are designed in a slender rectangular shape, and juxtaposed with each other so as to be spaced from each other in the up-and-down direction of the display region 8, and electrically connected to all the gate wires 11 via the lines 11.

The source drivers 18 input predetermined image signals to the signal lines 12, and are formed in a slender rectangular shape. They are juxtaposed with one another so as to be spaced from one another in the right-and-left direction of the display region 8 as shown in FIG. 5, and electrically connected to all the signal lines 12 via the wires 18a.

A plurality of array boards 3 are arranged in a matrix form on a large-sized mother board 29 as a mother glass (large-sized board) of the glass board G.

The counter board 4 has a glass board (not shown) as a substantially transparent and plate-like rectangular insulating board (not shown) having translucence, and a colored layer (not shown), a counter electrode as a common electrode and an orientation film formed by conducting orientation processing of polyimide are successively formed on the whole surface corresponding to one principal surface of the glass board which faces the array board 3.

A plurality of counter boards 4 whose number corresponds to the number of array boards 3 are arranged in a matrix form on the large-sized mother board (not shown) as the mother glass (large-sized board) so as to be located at the positions corresponding to the array boards 3 provided on the large-sized mother board 29.

The liquid crystal layer 5 is formed by injecting and sealing liquid crystal composition in a liquid crystal sealing region which is formed via a spacer as an inter-board gap material between the orientation film of the counter board 4 and the orientation film of the array board 3.

As a result, the liquid crystal panel 1 can make a predetermined image be visible by switching the thin film transistor 15 of each pixel 7 to apply a video signal to the pixel electrode and controlling the orientation of the liquid crystal composition in the liquid crystal layer 5, thereby modulating light transmitted through the colored layer of the array board 3.

Next, a method for manufacturing the liquid crystal display device according to the first embodiment will be described.

First, the film forming step and the patterning step are repeated to form the thin film transistors 15, etc., on the large-sized mother board 29, thereby forming a plurality of array boards 3.

That is, first, the film of each of the compounds such as aluminum, molybdenum, etc., is formed on the surface of the transparent large-sized mother board 29 at a predetermined film thickness by sputtering or the like and then patterned in a predetermined shape by photolithography, thereby forming the gate lines 11 on the surface of the transparent large-sized mother board 29.

Subsequently, the gate insulating film 21 formed of silicon nitride, for example, is formed.

Furthermore, an active layer of the thin film transistors 15, the signal lines 12, the drain lines, etc., are properly formed above the gate insulating film 21, and also the interlayer insulating film 23 is formed of silicon nitride, for example, and patterned by photolithography.

Thereafter, the gate insulating film 21 and the interlayer insulating film 23 are subjected to dry etching by using a predetermined resist pattern (not shown) or the like formed on the interlayer insulating film 23 as a mask and also using predetermined etching gas in a vacuum chamber (not shown) or the like, thereby forming the contact holes 25 and 26 and the dummy holes 27.

At this time, the luminescence amount of plasma, that is, the etching waveform in the vacuum chamber is detected to observe the progress of the etching.

That is, as shown in FIG. 6, the luminescence (light emission intensity) is successively reduced from the start of detection of light emission in connection with the consumption of etching gas as the etching progresses (time T1 to T2). The consumption of the etching gas is reduced subsequently to the time T2 at which the etching of the gate insulating film 21 is completed, so that the amount of the etching gas occupying the atmosphere inside the vacuum chamber is increased and thus the luminescence intensity successively increases (time T2 to T3).

Accordingly, the etching is completed while the period from the time T2 at which the etching is completed until the time T3 at which the increase in the luminescence intensity starts is set as the just etching timing.

On the other hand, the colored layer, the counter electrode and the orientation film are successively formed on the surface of the large-sized mother board, and adhesive agent as a sealing material is coated along the peripheral edge of the orientation film of the counter board 4 except for a liquid crystal injection port (not shown) from which the liquid crystal composition is injected. The adhesive agent is subjected to irradiation of ultraviolet rays or the like to be hardened while the orientation film of the array board 3 and the counter board 4 are disposed to face each other, thereby adhesively attaching the large-sized mother boards. Thereafter, the large-sized mother boards are cut along scribe lines SL by each size of liquid crystal panels 1. At this time, each portion between the liquid crystal panels 1 becomes an end member portion PA to be cut out.

The liquid crystal composition is injected from the liquid crystal injection port into the cut liquid crystal panel 1 and filled in the liquid crystal sealing region to form the liquid crystal layer 5, and the liquid crystal injection port is sealed by ultraviolet ray hardenable resin or the like, thereby manufacturing a color displayable liquid crystal panel 1.

As described above, according to the first embodiment, the contact holes 25 and 26, the dummy holes 27 different from the contact holes 25 and 26 are formed in the gate insulating film 21 located in the non-display region 9 of the array board 3 or the interlayer insulating film 23 by the dry etching, so that the opening area ratio of the array board 3 is enhanced. Therefore, the variation amount of luminescence of etching gas during the dry etching becomes large, and the just etching timing can be easily detected by detecting the variation amount by the luminescence measuring device.

Particularly, by setting the opening area ratio of the contact holes 25 and 26 and the dummy holes 27 of the gate insulating film 21 in the range from 1.2% to 1.5%, occurrence of operation failure (endpoint defect) due to detection failure of the just etching timing can be prevented and also the time required for the processing can be prevented from being long, so that the yield and the manufacturing performance can be secured.

Furthermore, the dummy holes 27 and the contact holes 25 and 26 are formed at the same time, and thus it is merely required to change only one layer of mask for forming the contact holes 25 and 26 in accordance with the dummy hole 27, and the manufacturing performance can be secured.

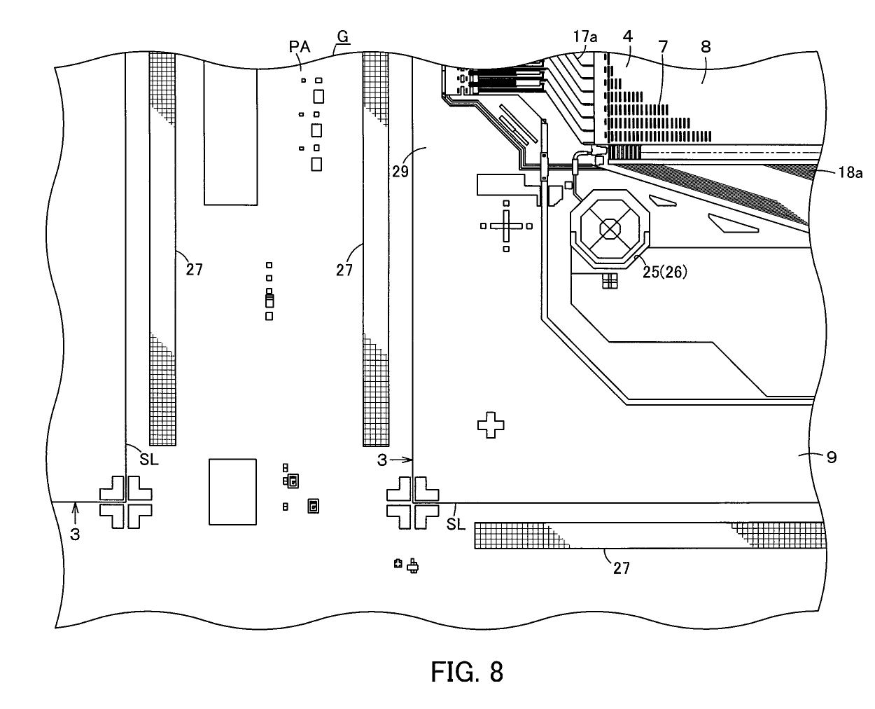

Next, a second embodiment will be described with reference to FIG. 8. The same constructions and operation as the first embodiment are represented by the same reference numerals, and the description thereof is omitted.

In the second embodiment, the dummy holes 27 are provided out of the parting lines, that is, the scribe lines SL of the respective glass boards G of the large-sized mother board 29.

That is, the dummy holes 27 are not formed on each liquid crystal panel 1, but formed on the end member portion PA which is cut out from the scribe line SL.

In this case, the opening area ratio is secured by the dummy holes 27, whereby the same effect as the first embodiment can be attained. In addition, the end member portion PA is cut out and thus it does not constitute a part of the liquid crystal panel 1, so that the dummy holes 27 can be easily formed without strict consideration of the surrounding arrangement, etc.

In each of the above embodiments, any position such as the non-display region 9, the outside of the scribe line SL or the like may be set as the position of the dummy hole 27 insofar as it hardly affects the display region 8.

Furthermore, the details of the liquid crystal panel 1 are not limited to the above construction.

What is claimed is:

1. A liquid crystal display element including a display region having a plurality of pixels and a non-display region located outside of the display region comprising:
an array board having an insulating film;
a counter board disposed so as to face the array board;
a liquid crystal layer interposed between the array board and the counter board;
an opening pattern formed in the insulating film located at least in the display region by dry etching; and
a dummy opening pattern that is formed in the insulating film located in the non-display region by dry etching separately from the opening pattern.

2. The liquid crystal display element according to claim 1, wherein the dummy opening pattern has a larger opening area ratio than that of the opening pattern of the insulating film.

3. The liquid crystal display element according to claim 2, wherein the opening area ratio of the opening pattern and the dummy opening pattern of the insulating film is set at a range from 1.2% to 1.5%.

4. The liquid crystal display element according to any one of claims 1 to 3, wherein the dummy opening pattern is formed to be elongated along the side portion of the array board and have minute hole portions arranged in a grid shape.

5. A method for manufacturing a liquid crystal display element which has an array board having an insulating film, a counter board disposed so as to face the array board, and a liquid crystal layer interposed between the array board and the counter board, and is equipped with a display region having a plurality of pixels and a non-display region located outside of the display region, wherein an opening pattern and a dummy opening pattern different from the opening pattern are formed in the insulating film by dry etching.

6. The method for manufacturing the liquid crystal display element according to claim 5, wherein the dummy opening pattern is formed at an opening area ratio larger than that of the opening pattern of the insulating film.

7. The method for manufacturing the liquid crystal display element according to claim 6, wherein the opening area ratio of the opening pattern and the dummy opening pattern of the insulating film is set at a range from 1.2% to 1.5%.

8. The method for manufacturing the liquid crystal display element according to any one of claims 5 to 7, wherein the dummy opening pattern is formed to be elongated along the side portion of the array board and minute hole portions are arranged in the form of a grid.

9. The method for manufacturing the liquid crystal display element according to any one of claims 5 to 8, wherein the dummy opening patterns are formed outside a parting line when the array board is divided from a large-sized board.
